(19) United States
(12) Patent Application Publication
(10) Pub. No.: US 2004/0140059 A1
(43) Pub. Date: Jul. 22, 2004

(54) PORTABLE TIRE BEAD BREAKER

(76) Inventor: John Lewis Wagner, Plainwell, MI (US)

Correspondence Address: JOSEPH KOORKIN ANDONIAN, 5137 RIDGEBROOK DRIVE, PORTAGE, MI, 49002, US

(21) Appl. No.: 10/346,455

(22) Filed: Jan. 17, 2003

(51) Int. Cl. B60C 25/128

(52) U.S. Cl. 157/1.28

(57) ABSTRACT

A lightweight tire bead breaker suitable for breaking the beads of a tire mounted on a wheel in one continuous operation by a single individual. The invention has an H shaped frame with a hinge in the crossing member, an actuator on one side of the hinge with sufficient power to enable shoes on the other side of the hinge to break the beads of the outside tire mounted on a dual wheel, even while the wheel is attached to a vehicle. The invention can also be used advantageously after a wheel has been removed from a vehicle.

This invention relates to equipment to facilitate the removal of tires for the purposes of repair or replacement from the wheels upon which they are normally mounted. More particularly the equipment facilitates breaking tire beads from the rim of a wheel.

### BACKGROUND OF THE INVENTION

Recently issued U.S. Pat. No. 6,305,453 is directed to tire bead breaking equipment and adequately summarizes the prior art relating to tire bead breaking equipment. The patent also claims the same general advantages over the prior art as the present invention, namely convenience, portability, cost, adequacy of power, speed of operation and usefulness on tires of different sizes. The present invention is even more capable of providing those advantages, especially portability, cost and speed of operation.

The process of breaking a bead to take a tire off of a wheel normally requires that the wheel be removed from the vehicle and transported to a repair facility where the beads can be broken using equipment located in the facility. The present invention uniquely provides equipment that is so lightweight and portable that it can used in the field by a single operator, such as a commercial mobile tire service technician, to remove the outside tire on the dual wheel of a semi-truck without removing the wheel on which the tire is mounted. Using the present invention this task can be accomplished easily and efficiently by a single individual in seconds instead of the several minutes required to accomplish the same task using normal procedures and conventional equipment in a tire repair facility. The present invention can also be used advantageously after a wheel has been removed to break down both beads in one continuous operation instead of separate procedures to break each bead separately.

### SUMMARY OF THE INVENTION

The present invention comprises an apparatus suitable for breaking both beads of a tire mounted on a wheel rim in one continuous operation. The apparatus has an H-shaped frame with right and left vertical components having an upper end and a lower end and a horizontal component connecting the vertical components. A centrally located hinge mechanism is built into the horizontal component. A shoe is attached to the lower end of each vertical component with the toes of the shoes pointing toward each other. An actuator is installed between the upper ends of each vertical component. The actuator is adapted to force the upper ends of each vertical component to move outward (i.e., away from each other) and thereby put sufficient pressure on the shoes to move inward (i.e., toward each other) and break the beads of a tire when the lower ends of the apparatus are clamped over a tire mounted on a wheel. The actuator can be a pneumatic, electric, hydraulic or mechanical device or a combination of these suitable to deflect the upper ends of the vertical component and rotate the components about the hinge with sufficient pressure on the shoes to break the beads of a tire mounted on a wheel. The shoes should have a toe with sufficient surface to engage the side-walls of a tire without puncturing the tire, a sole of sufficient length to break the beads and a heel of sufficient breath and surface to engage the rim of a wheel on which a tire is mounted to prevent the shoe from extending into the tire beyond the distance required to break the bead. All parts of the shoe should be sturdy enough to perform their functions repeatedly without structural failure. A spring is preferably located between the upper ends of the vertical components and the horizontal component to return the upper ends to their original positions after breaking the beads. A cart can be used to transport the apparatus with less effort and to position the apparatus for convenient access to a tire mounted on a wheel. Handles can also be attached to the apparatus and are most useful in the field to position the apparatus manually over a tire that is mounted on a wheel that is still attached to a vehicle.

It is an object of the present invention to provide equipment that can break down both beads of a tire mounted on a wheel in one continuous operation with greater convenience, economy, versatility, and portability at lower cost than the bead breakers of the prior art. Another object is to provide equipment that can be handled and operated by a single individual remotely from a garage where most tires are taken to break the beads and complete the removal and repair or replacement of the tire. A further object is to provide equipment that is also rugged enough to carry out the foregoing functions safely and repeatedly.

### BRIEF DESCRIPTION OF THE DRAWINGS

FIG. 1 is a perspective view of the bead breaking apparatus of the present invention.

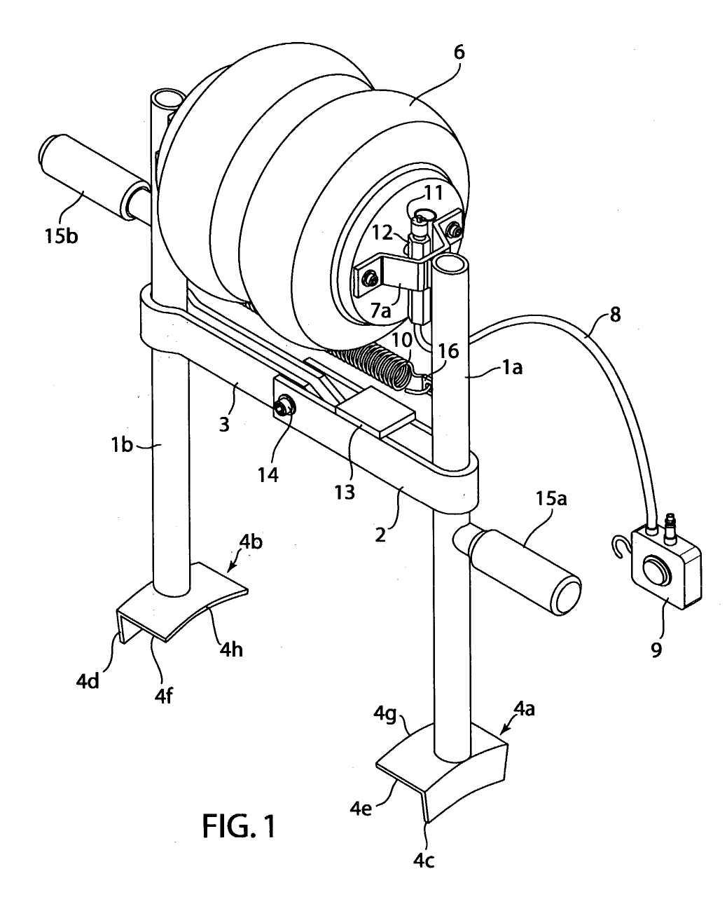

FIGS. 2, 3 and 4 are front, top and side views showing the apparatus is greater detail.

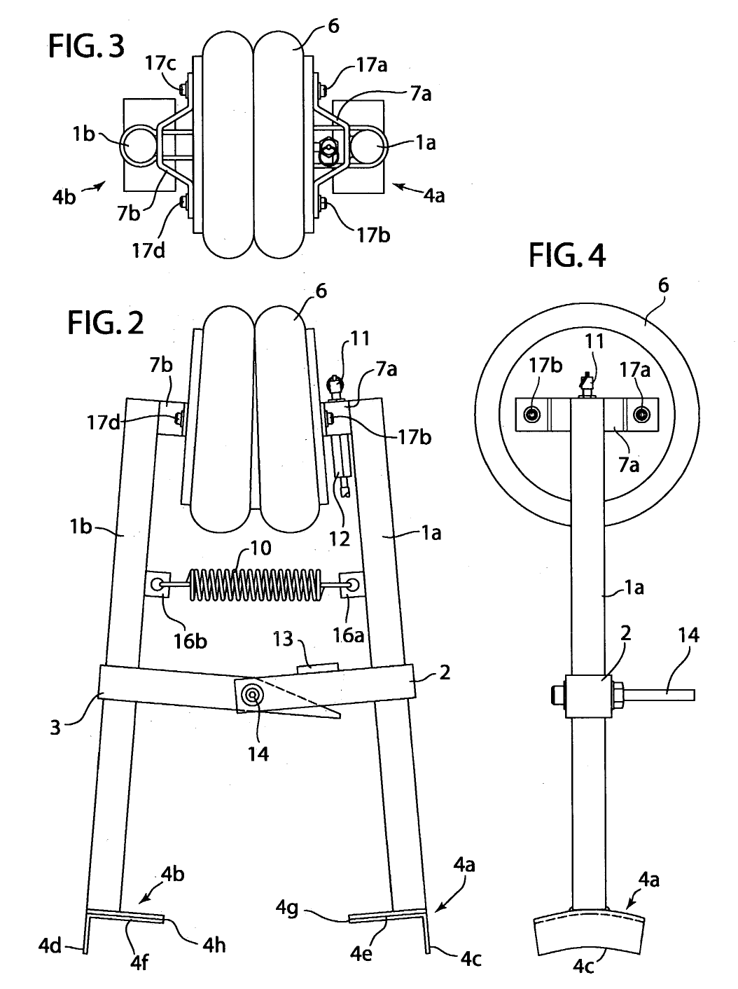

FIG. 5 is a perspective view of the apparatus positioned over a tire on a wheel.

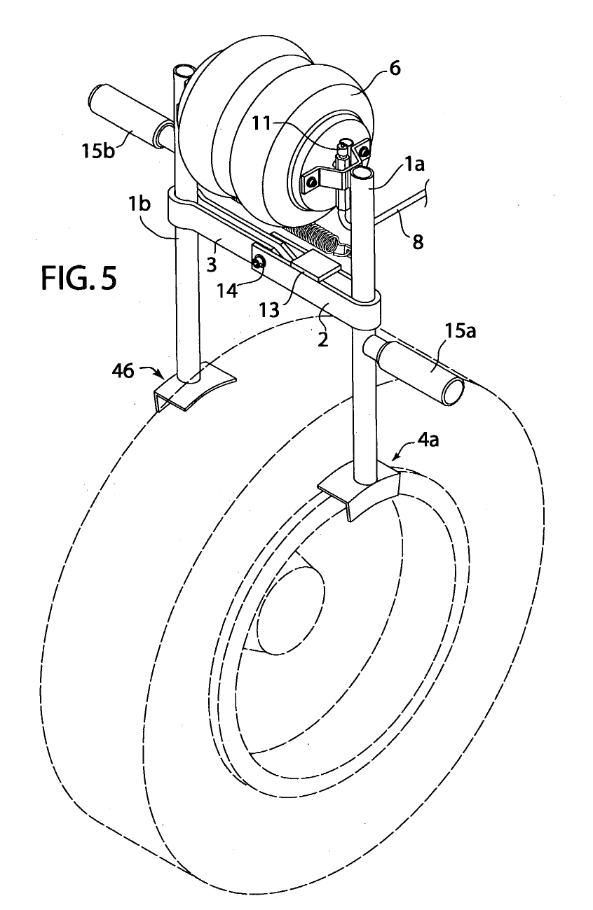

FIGS. 6 and 7 show the apparatus positioned over a tire mounted on a wheel before and after the beads are broken.

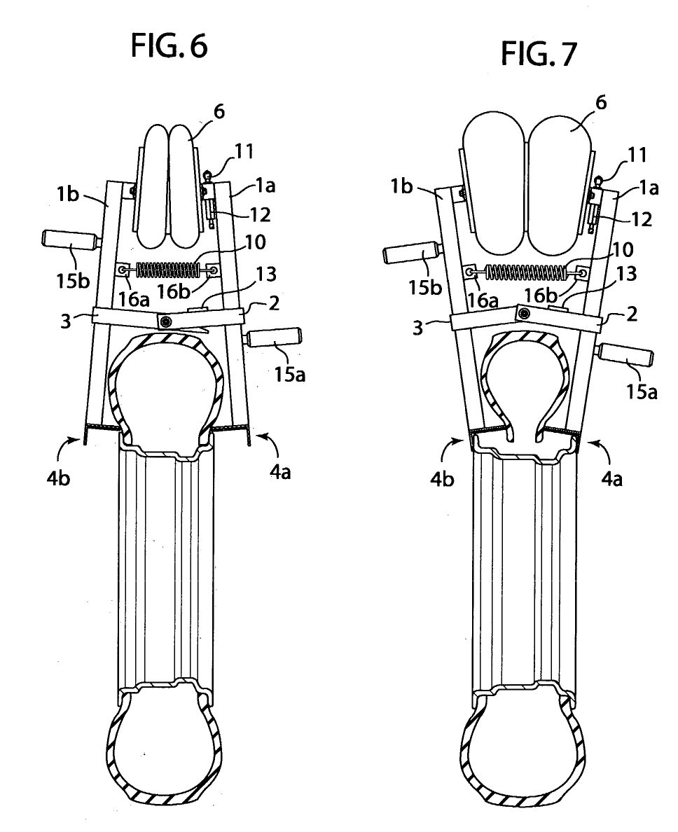

FIG. 8 is a perspective view of the bead breaking apparatus and a cart for transporting and positioning the apparatus.

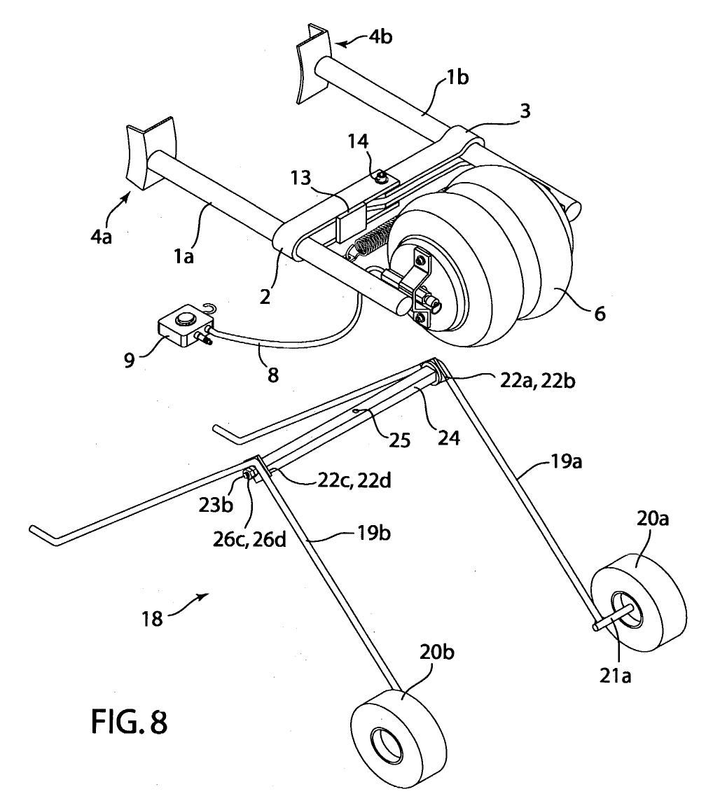

### LIST OF REFERENCE NUMERALS

1a, 1b Right and left vertical supporting components

2 Female portion of horizontal component

3 Male portion of horizontal component

4a, 4b Right and left shoes

4c, 4d Heels (stop) of right and left shoes

4e, 4f Soles of right and left shoes

4g,4h Toes of right and left shoes

6 Air bag

7a, 7b Right and left brackets

8 Air hose

9 Foot valve

10 Spring

11 Pop off valve

12 Tee

13 Hinge stop

14 Hinge pin

15a, 15b Right and left handles

16a, 16b Right and left eyed brackets

17a,17b,17c,17d Bolts

18 Cart

19a,19b Supporting rods for cart

20a,20b Cart wheels

21a,21b Cart axles

22a,22b,22c,22d Strap iron pieces

23a,23b Bolts

24 Square tube

25 Hole in square tube

26a,26b,26c,26d Nuts

### DETAILED DESCRIPTION

Two shoes 4a, 4b are formed from two 5½ inch long, 3½ inch wide, 1/4 inch thick pieces of strap iron that are first bent at a 90 degree angle along their entire length 1 inch from one side. The angled pieces are then curved across their entire length in the same direction as the 90 degree bend to a radius of 12¼ inches and function as the heels 4c,4d, soles 4e,4f and toes 4g,4h of the shoes 4a, 4b. The top of each of the curved soles 4e,ef of shoes 4a, 4b are then centered on one end of two round twenty four inch long steel pipes having a 1 1/4 inch inside diameter and a 1⅝ inch outside diameter 1a, 1b so that the heels 4c,4d of the shoes 4a, 4b are flush with one side of the pipes 1a, 1b and the open sides of the curved soles 4e,4f are facing away from the end of the pipes 1a, 1b. The pipes 1a, 1b function as the right and left vertical supports of the H-shaped apparatus of the present invention. The toes 4g,4h are broad enough to contact the sidewalls of a tire during the bead breaking process without puncturing the tire; the heels 4c,4d are long and wide enough when contacting the rim of the wheel on which the tire is mounted to prevent the shoes 4a,4b from penetrating the tire beyond what is necessary to break the beads, and the soles 4e,4f are long and broad enough to allow the shoes 4a,4b to rest on the rim of the wheel and allow the toes 4g,4h and heels 4c,4d to perform their functions.

A 1×1¼ inch bracket with a centered 1/4 inch hole 16a,16b are welded to each pipe 1a,1b 8 inches from the bare (unshoed) end of each pipe 1a,1b so that the brackets 16a,16b extend in the same direction away from the pipes 1a,1b as the toes 4g,4h of the shoes 4a,4b on the pipes 1a,1b.

A 16¾ inch long, 2 inch wide, ¼ thick piece of strap iron is formed into the shape of an elongated letter U with a 1⅝ inch gap between the sides of the U. A 17/32 inch hole centered in the 2 inch width of the strap is drilled 6½ inches from the bottom of the U to produce the female portion 2 of the horizontal component of the H-shaped apparatus of the present invention.

A second 20¾ inch long, 2 inch wide, ¼ inch thick piece of strap iron is also formed into the shape of an elongated letter U with a 1⅝ inch gap. A 1/4 inch offset is pressed inwards on both ends of this piece of strap iron, the offset extending to a point 3 inches from the curved or bottom end of the U. The separation between the ends of the second U is therefore a 1⅛ inch gap. Both ends of the second U are cut at a 32 degree angle 3/4 inch from both ends of the U and a 17/32 inch hole centered in the 2 inch width of the strap is drilled 6½ inches from the bottom of the U to produce the male portion 3 of the horizontal component of the present apparatus.

The open ends of the U shaped piece with the square ends or female portion of the horizontal component 2 is slid over the pipe 1a so that the square ends are facing in the same direction as the toe 4g of the shoe 4a and tack welded to pipe 1a 10 inches from the top or bracketed end of pipe 1a. The weld is positioned on both the top and the bottom of the strap 2 on the side of the pipe 1a opposite the toe 4g of the shoe 4a on pipe 1a. The open ends of the second U shaped piece with the 32 degree angled ends of the male portion of the horizontal component 3 is similarly slid over the other pipe 1b so that the 32 degree angles are facing upward or toward the bracketed end of the pipe 1b and the angled ends are fitted between the square ends of the female portion 2. The male portion 3 is positioned and tack welded on the second pipe 1b in the same manner as the female portion 2 is positioned and welded to the first pipe 1a. The male and female portions 2,3 of the horizontal component are secured to each other with a 5 inch pin 14 having a ½ inch diameter and a 1½ inch×1/8 inch cotter pin (not shown). This joint functions as a hinge about which the two vertical components 1a,1b can rotate. The pin 14 is long enough to engage the hole 25 in the square tube 24 of the cart 18.

Two brackets 7a,7b are formed from 9¼ inch long, 2 inch wide, 1/4 inch thick pieces of strap iron. Two 7/16 inch diameter holes are centered and drilled 7/8 inch from each end of each piece. The drilled pieces of strap iron are then bent to form a 1¾ inch offset beginning 2 inches from each end but leaving both ends lined up with each other in the same plane. The brackets 7a,7b are welded flush to the top or open end of the pipes 1a,1b with the open sides facing each other in the same direction as the toes 4g,4h of the shoes 4a,4b.

A 2 inch, 1¼ wide, 1/4 inch thick piece of strap iron 13 is positioned and welded into place over the top of the female strap 2 so that the angled end of the male strap 3 would come into full contact with it if the bracketed ends of the vertical components 1a,1b are spread apart, thus limiting the rotation of the vertical components 1a,1b about the hinge. This stop 13 protects the user of the bead breaker from activating the air bag 6 and cause the shoes 4a,4b to clamp more than what is necessary to break the beads of a tire yet far enough to accidentally pinch the arm or leg of a user. The stop 13 also prevents damage to the air bag 6 by expanding beyond the point recommended by the manufacturer.

A 1/4 inch NPT short nipple (not shown) is screwed into the opening (not shown) provided for attachment of an air hose to a Goodyear model 2B 12-425 air bag 6 that acts much like a bellows and functions as the actuator for the present apparatus. A ¼ inch NPT tee 12 is plumbed bull headed into the nipple and one end of a 5 feet long ⅜ 100 PSI air hose 8 with ¼ inch male ends is attached to one side of the tee 12. A 1/4 inch NPT 100 PSI pop off valve 11 is attached to the other side of the tee 12. The air bag 6 with the attached hose 8 is attached between the bracketed ends of the two vertical components 1a,1b using 4-3/8 inch×1 inch NC bolts (17a,17b,17c,17d). A 1/4 inch foot valve 9 is attached to the open end of the air hose 8. The pop off valve 11 prevents over-inflation of the air bag 6.

A 1¼ inch stress proof cold rolled steel rod (not shown) having a length of 23¾ inches is preferably inserted into the pipes 1a,1b to reinforce the vertical components. The ends of the pipes are sealed by crimping the ends of the pipes.

A 6 inch 100 pound test return spring 10 looped at both ends is attached to the eyed brackets 16a, 16b on both vertical components 1a, 1b.

Handles 15a,15b are added to the bead breaker by welding one 15b to the left pipe 1b above the male portion 3 of the horizontal crossing member and the other handle 15a to the right pipe 1a below the female portion 2 of the crossing member. The exact location of the handles 15a,15b is not critical but they should be closer to the crossing member than they are to the top or bottom of the pipes 1a,1b. This particular arrangement provides better balance making manipulation of the bead breaker by a single individual easier than it would be if the handles 15a,15b were directly opposite one another or even offset entirely above or below the crossing member.

After painting and labeling the finished product is ready for use as a tire bead breaker.

The described apparatus can to used by connecting the hose 8 to an air compressor, positioning the shoed ends of the vertical components 1a, 1b over each sidewall of a tire mounted on a wheel so the sole 4e,4f of each shoe 4a, 4b sits on each rim of the wheel, expanding the air bag 6 using an air compressor to deliver air through the air hose 8, causing the arcuate toe 4g,4h of each shoe 4a, 4b to clamp on the sidewalls of the tire and thereby break the beads in one continuous operation, turning off the air compressor, allowing the spring 10 to return the shoes 4a, 4b to their normal position and removing the apparatus from the wheel. The tire can then be removed from the wheel using a simple spoon to lever the tire off the wheel.

A cart 18 to facilitate transportation and use of the above apparatus can be fashioned from 2-5/8 inch hot roll steel rods 19a,19b having a length of 48 inches; 2-6 inch wheels 20a,20b with a 100 pound capacity and a centered 1/2 inch hole; 2-½ inch cold roll round axles 21a,21b with a length of 3 inches; 4-2×2×¼ inch pieces of strap iron 22a,22b,22c,22d with a ½ inch hole centered on each piece; 2-½ inch NF bolts 23a.23b; 4 1/2 inch NF nuts 26a,26b,26c,26d; and 1-1×1×⅛ inch rectangular steel tube 24 with a 9/16 inch hole 25 drilled through both 1 inch sides in the center of the tube. One end of each of the hot roll rods 19a,19b is bent at a 45% angle. Measuring 24 inches from the heel of the 45% bend, each hot roll rod 19a,19b is bent again at a 90% angle keeping both angled portions of the rod 19a,19b angled in opposite directions but in the same plane. The ½ inch axles 21a,21b are welded to the unbent ends of the hot roll rod 19a,19b at an angle that is perpendicular to the plane of the 90% bend but in such a direction that the axles 21a,21b point in opposite directions when the rods 19a,19b are placed side by side. One of the strap iron pieces 22b,22d is welded on the inside of the 90% bend of each hot roll rod 19a,19b (that is, on the opposite side of the rods 19a,19b from the direction the axles 21a,21b are pointed). One of the bolts 23a,23b is then inserted into each hole on each of the remaining strap iron pieces 22a,22c and the head of the bolt 23a,23b is welded to each piece 22a,22c. The welded head of each bolt 23a,23b is then inserted into the hole on each end of the square tube 24 and secured in place by welding. A plastic washer is fitted over the exposed end of each bolt 23a,23b which are then inserted into each of the strap iron pieces 22b,22d which were previously welded to the hot roll rods 19a,19b. The bolts 23a,23b are secured with the nuts 26a,26b and tightened enough to restrict swivel motion of the tube 24 and locked with the remaining nuts 26c,26d to keep them from loosening. The wheels 20a,20b are then installed on the axles 21a,21b and secured with spring clips. Paint can be applied as desired.

To use the cart 18 the hinge pin 14 of the bead breaker apparatus should be long enough to fit securely into the hole 25 in the center of the square tube 24 of the cart. In this position the bead breaker can be transported as well as flexibly positioned for breaking the beads of tires that are rolled up to the bead breaker while it is on the cart 18. In other words, while still on the cart 18, the bead breaker can be adjusted up or down to fit comfortably over tires of various sizes that require the use of a bead breaker.

Thus the present invention provides equipment that is so lightweight and portable that it can be used in the field by a single operator, such as a commercial mobile tire service technician, to remove the outside tire on the dual wheel of a semi-truck without removing the wheel on which the tire is mounted. Actual experience under normal conditions has proven that the beads can be broken in eight seconds using the present equipment compared to 5 minutes and 8 seconds required to break the beads using conventional methods. A typical conventional method requires a person to get a jack, position the jack and lift the wheel off the ground, get a jack stand and install it, get a tool to remove the chrome nut covers, remove the ten covers, get an air impact wrench, remove the ten nuts, remove the wheel and tire assembly, position the wheel assembly on a bead breaking tool, and finally break down the beads, usually one bead at a time. All the present invention requires to break the beads is to connect the air hose to a source for compressed air (normally available on mobile tire service trucks in the field), fit the device over the tire and place the shoes on the rim of the wheel, and turn on the compressed air. The present invention will then break the beads in one continuous operation. In addition the conventional tire removal process requires that the operation take place on hard level surface and sometimes encounters damage to chrome nut covers or the wheel nuts. Moreover the conventional removal process is complicated by possible seizure of a wheel on an axle, seizure of the wheel lugs or even damage to the wheel itself during the removal process.

The foregoing provides both a general description and a specific description of the preferred embodiment of the invention. It should be understood that various substitutions, variations and modifications can be made by those skilled in the art without departing from spirit and scope of the invention as further delineated in the following claims.

I claim:

1. An apparatus suitable for breaking both beads of a tire mounted on a wheel rim in one continuous operation, said apparatus comprising an H-shaped frame having right and left vertical components with upper and lower ends, a horizontal component connecting the vertical components, a hinge mechanism built into the horizontal component, a shoe at the lower end of both vertical components, and an actuator between the upper ends of said vertical components above said horizontal component wherein the actuator when turned on is adapted to put sufficient outward pressure on the upper end of the vertical components and cause said shoes to break the beads of the tire by a clamping action brought about by the vertical components acting as levers pivoting on said hinge when the lower ends of the vertical components are placed over the tire and the shoes are resting on the rim of the wheel.

2. The tire bead breaker of claim 1 further comprising an air bag actuator.

3. The bead breaker of claim 2 further comprising an air hose connected to said actuator suitable for connecting to an air compressor and a pop off valve between said actuator and said air hose to prevent air pressure from exceeding the level necessary to break the beads.

4. The bead breaker of claim 1 further comprising shoes each having a toe, a sole and a heel wherein the toe has enough surface area to avoid puncturing the tire when pressed against the tire, the sole is long enough when placed on a rim of a wheel to break the beads a tire mounted on the rim when the shoe is actuated with sufficient force for that purpose and the heel has enough surface and strength to act as a stop when it contacts the rim of the wheel after the toe breaks the beads and thereby prevents the shoes from extending into the tire beyond what is necessary to break the beads.

5. The bead breaker of claim 1 further comprising a hinge mechanism that comprises a male and a female member wherein the male member butts up against a stop located on said female member to prevent the shoes from moving inwards beyond the point necessary to break the beads of a tire affixed to a wheel.

6. The bead breaker of claim 1 further comprising two handles, one affixed to the upper end of one of the right or left vertical components and the other affixed to the lower end the other of the right or left vertical component.

7. The tire bead breaker of claim 1 further comprising a spring connected to the upper ends of the vertical components between the actuator and the horizontal component with sufficient strength to return the upper ends to their unclamped positions once the tire beads have been broken and the actuator is turned off.

8. A tire bead breaking apparatus having an overall structure approximating a figure H, a left vertical side having a top and a bottom, a right vertical side having a top and a bottom and a horizontal crossing member connecting the two sides comprising (1) an actuator connected to and located between the top of the left side and the top of the right side, (2) a shoe having a toe, a sole and a heel, said shoe connected to the bottom of both the right and left sides, (3) a hinge located on the crossing member about midway between the right and left sides, (4) a spring connected to the right side and the left side and located between said actuator and said crossing member and (5) two handles, one connected to one of the right or left vertical sides above said crossing member and the other connected to the other of the right or left vertical sides below said crossing member, wherein (a) the bottoms of the right and left vertical sides are spaced far enough apart to fit over a tire mounted on a wheel, (b) the distance between the bottoms of the vertical sides and the crossing member is great enough to enable the shoes to contact a rim of the wheel, (c) the toes of the shoes are pointed toward each other and are far enough from the heels so that when the soles of the shoes are resting on the rim of a wheel over a tire and the upper ends of the vertical components are forced outward by the actuator the toes will be forced against the tire with sufficient force to break the beads on each side of the tire before the heel contacts the rim and acts as a stop.

9. A light weight tire bead breaker suitable for carrying and operating by hand comprisingan H-shaped frame having a top with two vertical legs pointed upward over a hinged horizontal crossing member and a bottom with two vertical legs pointing downward under said crossing member, an actuator affixed to the top of said frame, and a pair of shoes each having a toe flange and a heel flange affixed to the bottom of said frame on said downward pointing legs with said toes pointing toward each other away from said downward pointing legs and said heels pointing downward and parallel to said downward pointing legs wherein said actuator is adapted to press outward against said upward pointing legs causing the toes of said shoes on said downward pointing legs to press inward by a lever action of said legs pivoting on said hinge with sufficient force to break the beads of a tire mounted inside a wheel rim when said lower pointing legs are bracketed over said tire and said shoes are resting on said rim.

10. A cart having a horizontal support capable of swiveling up and down in combination with the bead breaker of claim 9 further comprising a pin on said hinge of said bead breaker which extends outward from said hinge sufficiently to engage a centrally located hole in said horizontal support thereby enabling said bead breaker to swivel up and down when said bead breaker is placed on said vertical support with said pin placed in said hole.
